(19) United States
(12) Patent Application Publication
(10) Pub. No.: US 2014/0118648 A1
(43) Pub. Date: May 1, 2014

(54) LIQUID CRYSTAL LENS, A LIQUID CRYSTAL MODULE HAVING THE LIQUID CRYSTAL LENS AND A METHOD OF DRIVING THE LIQUID CRYSTAL MODULE

(71) Applicant: SAMSUNG DISPLAY CO., LTD., Yongin-City (KR)

(72) Inventors: Il-Yong YOON, Seoul (KR); Soo-Hee OH, Gunpo-si (KR); Jin-Hwan KIM, Suwon-si (KR); Kyung-Ho JUNG, Seongnam-si (KR); Seung-Jun JEONG, Hwaseong-si (KR); Yong-Cheol JEONG, Yongin-si (KR)

(73) Assignee: SAMSUNG DISPLAY CO., LTD., Yongin-City (KR)

(21) Appl. No.: 13/834,403

(22) Filed: Mar. 15, 2013

(30) Foreign Application Priority Data
Oct. 26, 2012 (KR) 10-2012-0120038

(51) Int. Cl. G02F 1/1335

(52) U.S. Cl. CPC G02F 1/133526
USPC 349/37

(57) ABSTRACT

A liquid crystal lens includes a plurality of first sub liquid crystal portions having refractive indexes varied based on voltages applied thereto, a plurality of second sub liquid crystal portions having refractive indexes varied based on voltages applied thereto, where the second sub liquid crystal portions are adjacent to the first sub liquid crystal portions, respectively and a controller which controls the voltages applied to the first sub liquid crystal portions and the voltage applied to the second sub liquid crystal portions to provide a lens part.

This application claims priority to Korean Patent Application No. 10-2012-0120038, filed on Oct. 26, 2012, and all the benefits accruing therefrom under 35 U.S.C. §119, the content of which in its entirety is herein incorporated by reference.

### BACKGROUND

1. Field

Exemplary embodiments of the invention relate to a liquid crystal lens, a liquid crystal module having the liquid crystal lens and a method of driving the liquid crystal module including the liquid crystal lens. More particularly, exemplary embodiments of the invention relate to a liquid crystal lens including a plurality of lens having various focal positions, a liquid crystal module having the liquid crystal lens and a method of driving the liquid crystal module including the liquid crystal lens.

2. Description of the Related Art

Generally, when a Fresnel lens is disposed on a display panel, an image on the display panel is refracted to various directions. A general convex lens is projected on a plane to form the Fresnel lens. The Fresnel lens is generally used to display a three-dimensional (“3D”) image as lights passing through the Fresnel lens may be refracted to various directions.

FIG. 1 is a cross-sectional view illustrating an operation of a liquid crystal lens.

Referring to FIG. 1, a general convex lens 10 is projected on a plane to form a Fresnel lens 20. The Fresnel lens 20 may have a relatively thin and uniform thickness and may be used as an optical sheet. A liquid crystal lens 30 typically includes an upper electrode 31 and a lower electrode 33 and liquid crystal molecules. The liquid crystal lens 30 adjusts a refractive index according to a position so that the liquid crystal lens 30 functions as the Fresnel lens 20.

Generally, a resolution of the display panel may be increased to increase a resolution of the 3D image and the number of viewpoints. However, the resolution of the display panel may be limited due to a process limit.

### SUMMARY

Exemplary embodiments of the invention provide a liquid crystal lens driven using a time dividing method.

Exemplary embodiments of the invention provide a liquid crystal module including the liquid crystal lens.

Exemplary embodiments of the invention provide a method of driving the liquid crystal module.

In an exemplary embodiment of a liquid crystal lens according to the invention, the liquid crystal lens includes a plurality of first sub liquid crystal portions having refractive indexes varied based on voltages applied thereto, a plurality of second sub liquid crystal portions having refractive indexes varied based on voltages applied thereto, where the second sub liquid crystal portions are adjacent to the first sub liquid crystal portions, respectively and a controller which controls the voltages applied to the first sub liquid crystal portions and the voltage applied to the second sub liquid crystal portions to provide a lens part.

In an exemplary embodiment, each of the first sub liquid crystal portions and the second sub liquid crystal portions may include an upper electrode and a lower electrode, which are connected to the controller.

In an exemplary embodiment, the upper electrode and the lower electrode may not overlap each other.

In an exemplary embodiment, a width of the upper electrode and a width of the lower electrode may be equal to or greater than a minimum width defined in a manufacturing process of the upper and lower electrodes.

In an exemplary embodiment, the liquid crystal lens may have a plurality of focal points controlled by the controller.

In an exemplary embodiment, the voltages applied to provide the lens part may be inverted from voltages applied to provide an adjacent lens part.

In an exemplary embodiment of a liquid crystal lens according to the invention, the liquid crystal lens includes first to N-th sub liquid crystal portions having refractive indexes varied based on voltages applied thereto, and a controller which controls the voltages applied to the first to N-th sub liquid crystal portions to provide a lens part, where N is a natural number greater than 2.

In an exemplary embodiment, each of the first to N-th sub liquid crystal portions may include an upper electrode and a lower electrode, which are connected to the controller.

In an exemplary embodiment, the upper electrode and the lower electrode may not overlap each other.

In an exemplary embodiment of a liquid crystal lens according to the invention, the liquid crystal lens includes: a liquid crystal lens including a plurality of first sub liquid crystal portions having refractive indexes varied based on voltages applied thereto, a plurality of second sub liquid crystal portions having refractive indexes varied based on voltages applied thereto, where the second sub liquid crystal portions are adjacent to the first sub liquid crystal portions, respectively, and a controller which controls the voltages applied to the first sub liquid crystal portions and the voltages applied the second sub liquid crystal portions to provide a lens part; and a liquid crystal panel disposed under the liquid crystal lens, where the liquid crystal panel comprises a plurality of pixels.

In an exemplary embodiment, each of the first sub liquid crystal portions and the second sub liquid crystal portions may include an upper electrode and a lower electrode, which are connected to the controller.

In an exemplary embodiment, the upper electrode and the lower electrode may not overlap each other.

In an exemplary embodiment, a focal point of the lens part may be shifted by a half of a width of the pixel of the liquid crystal panel by the controller.

In an exemplary embodiment of a method of driving a liquid crystal module according to the invention, the method includes: providing a lens part using a plurality of first sub liquid crystal portions of a liquid crystal lens of the liquid crystal module and a plurality of second sub liquid crystal portions of the liquid crystal lens by controlling voltages applied to the first sub liquid crystal portions and voltages applied to the second sub liquid crystal portions, where the first sub liquid crystal portions has refractive indexes varied based on the applied voltages, the second sub liquid crystal portions have refractive indexes varied based on the applied voltages, and the second sub liquid crystal portions is adjacent to the first sub liquid crystal portions, respectively; and shifting the lens part by maintaining levels of the voltages applied to the first sub liquid crystal portions and changing levels of the voltages applied to the second sub liquid crystal portions.

In an exemplary embodiment, the liquid crystal module may include a liquid crystal panel disposed under the liquid crystal lens, and the liquid crystal panel may display an image of a frame, where the shifting the lens part is performed every frame.

In an exemplary embodiment, the voltages applied to provide the lens part may have a polarity different from voltages applied to provide an adjacent lens part.

In an exemplary embodiment, the shifting the lens part may include applying voltages having a polarity same as a polarity of the voltages applied to the first sub liquid crystal portion for the providing the lens part to the first sub liquid crystal portions, and applying voltages having a polarity opposite to a polarity of the voltages applied to the second sub liquid crystal portions for the providing the lens part to the second sub liquid crystal portion.

In an exemplary embodiment, the method may further include providing an inverted lens part by applying voltages having a polarity opposite to a polarity of the voltages applied to the first sub liquid crystal portions for the providing the lens part to the first sub liquid crystal portions and applying voltages having a polarity opposite to a polarity of the voltages applied to the second sub liquid crystal portions for the providing the lens part to the second sub liquid crystal portions, where the providing the inverted lens part may be performed after the shifting the lens part.

In an exemplary embodiment, the method may further include shifting the inverted lens part by applying voltages having a polarity opposite to a polarity of the voltages applied to the first sub liquid crystal portions for the shifting the lens part to the first sub liquid crystal portions and applying voltages having a polarity opposite to a polarity of the voltages applied to the second sub liquid crystal portions for the shifting the lens part to the second sub liquid crystal portions, where the shifting the inverted lens part may be performed after the providing the inverted lens part.

According to exemplary embodiments of the liquid crystal lens, the liquid crystal module including the liquid crystal lens and the method of driving the liquid crystal module, the liquid crystal lens includes a first sub liquid crystal part and a second sub liquid crystal part which are driven independently such that a single liquid crystal lens may function as a plurality of liquid crystal lenses.

In such embodiments, polarities of the first sub liquid crystal part and the second sub liquid crystal part are adjusted such that an efficiency of the liquid crystal lens is substantially improved.

### BRIEF DESCRIPTION OF THE DRAWINGS

The above and other features of the invention will become more apparent by describing in detailed exemplary embodiments thereof with reference to the accompanying drawings, in which:

FIG. 1 is a cross-sectional view illustrating an operation of a liquid crystal lens;

FIGS. 2A and 2B are plan views illustrating images displayed using two different lenses;

FIG. 3 is cross-section views illustrating an operation of lens portions of an exemplary embodiment of a liquid crystal lens;

FIG. 4 is cross-section views illustrating an exemplary embodiment of liquid crystal lenses that operate as the lenses of FIGS. 2A and 2B;

FIG. 5 is a cross-section view illustrating an exemplary embodiment of a liquid crystal lens according to the invention;

FIG. 6 is a conceptual diagram illustrating the liquid crystal lens of FIG. 5;

FIGS. 7A to 7C are conceptual diagrams illustrating an exemplary embodiment of a method of driving the liquid crystal lens of FIG. 5;

FIG. 8 is a conceptual diagram illustrating an alternative exemplary embodiment of a liquid crystal lens according to the invention; and

FIGS. 9A to 9D are conceptual diagrams illustrating an exemplary embodiment of a method of driving a liquid crystal lens of a liquid crystal module according to the invention.

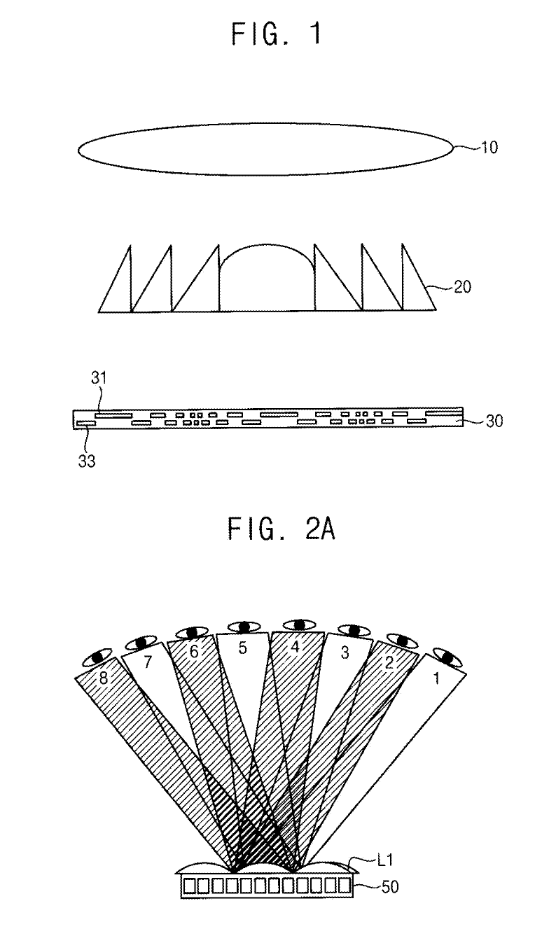

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

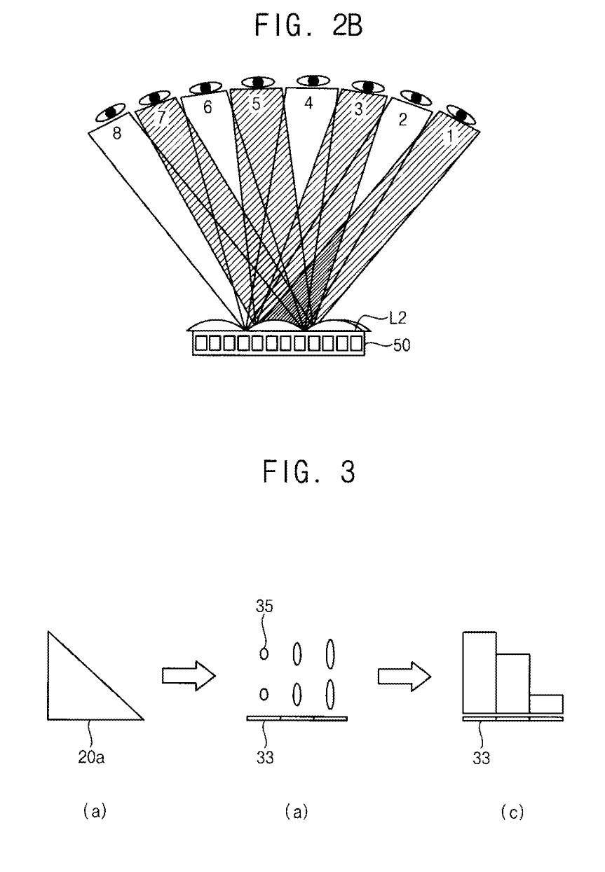

FIGS. 2A and 2B are plan views illustrating images displayed using two different lenses.

Referring to FIG. 2A, a liquid crystal panel 50 displays an image. The image on the display panel 50 is transmitted to a viewer through a first lens part L1. The liquid crystal panel 50 includes a plurality of pixels. A black matrix is disposed between the pixels. When the viewer views the liquid crystal panel 50 including the black matrix and the pixels, which are alternately disposed, through the first lens part L1, a bright region and a dark region are alternately displayed to the viewer due to the black matrix. In FIG. 2A, bright images are shown in first, third, fifth and seventh viewpoints and dark images are shown in second, fourth, sixth and eighth viewpoints.

Referring to FIG. 2B, the liquid crystal panel 50 displays the image. The image on the display panel 50 is transmitted to a viewer through a second lens part L2. When the viewer views the liquid crystal panel 50 including the black matrix and the pixels, which are alternately disposed, through the first second part L2, a bright region and a dark region are alternately displayed to the viewer due to the black matrix. In FIG. 2A, dark images are shown in first, third, fifth and seventh viewpoints and bright images are shown in second, fourth, sixth and eighth viewpoints.

Therefore, when the first lens part L1 and the second lens part L2 are alternately turned on and off, the bright image and the dark image are alternately shown to an eye of the viewer such that the number of the viewpoints or the frequency of viewpoint images may be increased, e.g., doubled. When the first lens part L1 and the second lens part L2 are alternately applied and the liquid crystal panel 50 alternately displays a left image for a left eye of the viewer and a right image for a right eye of the viewer every frame, the left image is viewed at the left eye of the viewer and a black image is viewed at the right eye of the viewer in a first frame and the right image is viewed at the right eye of the viewer and a black image is viewed at the left eye of the viewer in a second frame. Thus, the viewer may recognize three-dimensional (“3D”) image.

FIG. 3 is cross-section views illustrating an operation of lens portions of an exemplary embodiment of a liquid crystal lens.

Referring to FIG. 3, a process of forming a lens portion of the liquid crystal lens corresponding to a portion of a Fresnel lens 20a will be described. The Fresnel lens 20a includes a plurality of divided portions. As shown in (a) of FIG. 3, a refracting angle of light at the Fresnel lens 20a is adjusted according to a thickness of the Fresnel lens 20a such that the light is refracted to a predetermined direction corresponding to the thickness of the Fresnel lens 20a. In an exemplary embodiment, a refracting angle of the light is adjusted according to a refractive index of liquid crystal molecule of the liquid crystal lens. As shown in (b) of FIG. 3, the liquid crystal lens includes an electrode 33 and liquid crystal molecules 35. A voltage corresponding to the thickness of the Fresnel lens 20a is applied to the electrode 33 such that the liquid crystal molecules 35 are aligned in various directions, e.g., directions corresponding to the voltage applied to the electrode 33. In one exemplary embodiment, for example, different voltages are applied to a plurality of electrodes 33, respectively, such that the liquid crystal molecules 35 have refractive indexes according to a position. Thus, as shown in (c) of FIG. 3, the liquid crystal lens functions as a lens having a shape similar to the Fresnel lens 20a. The Fresnel lens 20a has a plurality of divided portions. In a similar way, the liquid crystal lens has the liquid crystal molecules corresponding to the divided portions of the Fresnel lens 20a, and the voltages corresponding to the electrodes 33 corresponding to the portions of the liquid crystal molecules 35 are applied to the electrodes 33 such that the liquid crystal lens functions as the Fresnel lens 20a.

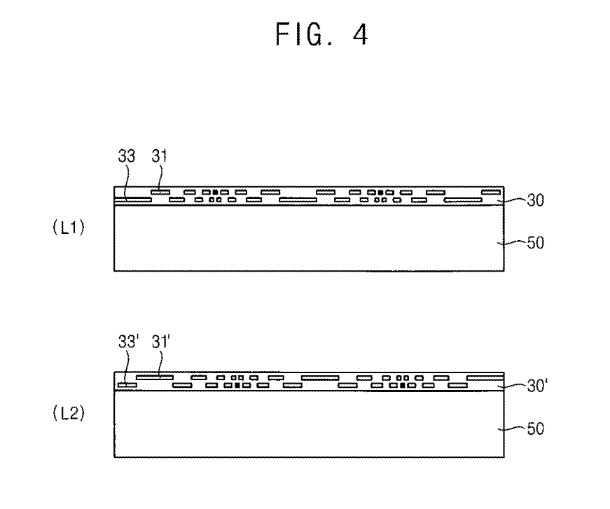

FIG. 4 is cross-section views illustrating an exemplary embodiment of liquid crystal lenses that operate as the lenses of FIGS. 2A and 2B.

Referring to FIGS. 2A, 2B and 4, a first liquid crystal lens L1 includes a substrate 30, an upper electrode 31, a lower electrode 33 and a liquid crystal layer 50. A second liquid crystal lens L2 includes a substrate 30′, an upper electrode 31′, a lower electrode 33′ and a liquid crystal layer 50. Voltages are applied to the upper electrode 31 and the lower electrode 33 of the first liquid crystal lens L1 such that an electric field is generated between the upper electrode 31 and the lower electrode 33. In such an embodiment, a refractive index of the liquid crystal layer 50 is determined based on the electric field. Lengths of the upper electrode 31 and the lower electrode 33 correspond to lengths of lens portions. In a similar way, voltages are applied to the upper electrode 31′ and the lower electrode 33′ of the second liquid crystal lens L2 such that a refractive index of the liquid crystal layer 50 is determined.

In an exemplary embodiment, the first liquid crystal lens L1 and the second liquid crystal lens L2 are alternately provided on a display panel and images are displayed corresponding to the liquid crystal lenses L1 and L2 to provide a 3D image to a viewer. However, the electrodes of the first and second liquid crystal lenses L1 and L2 are generally provided in predetermined positions and not movable such that the first and second lenses L1 and L2 may not be varied according to the images.

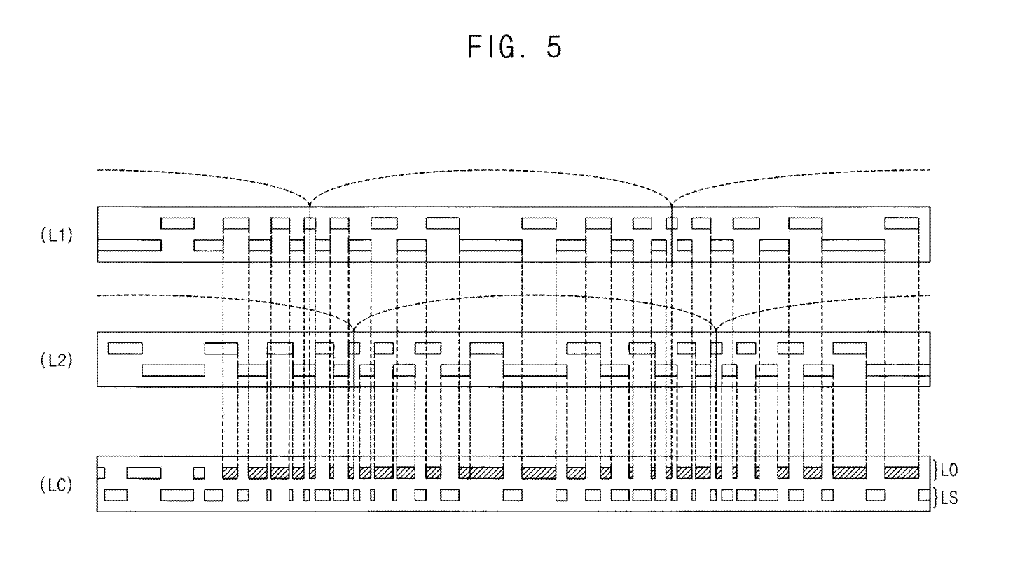

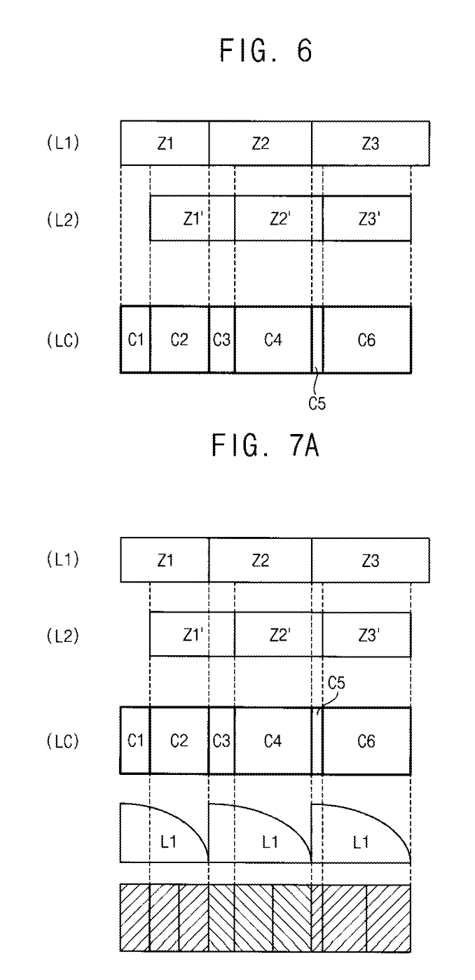

FIG. 5 is a cross-section view illustrating an exemplary embodiment of a liquid crystal lens according to the invention. FIG. 6 is a conceptual diagram illustrating the liquid crystal lens of FIG. 5.

Referring to FIGS. 5 and 6, an exemplary embodiment of the liquid crystal lens LC includes both of the first liquid crystal lens L1 and the second liquid crystal lens L2. In such an embodiment, the liquid crystal lens LC includes a first sub liquid crystal portion C2, C4 and C6 and a second sub liquid crystal portion C1, C3 and C5. Voltages are selectively applied to one of the first sub liquid crystal portion C2, C4 and C6 and the second sub liquid crystal portion C1, C3 and C5 such that the liquid crystal lens LC functions as the first lens L1 and the second lens L2.

Referring to FIG. 5, positions of electrodes of the liquid crystal lens LC are determined based on positions of electrodes of the first liquid crystal lens L1 and the second liquid crystal lens L2. The first liquid crystal lens L1 and the second liquid crystal lens L2 have substantially the same shape as each other, but a focal point of the second liquid crystal lens L2 is shifted from a focal point of the first liquid crystal lens L1. Thus, the liquid crystal lens LC may include an overlap electrode LO commonly corresponding to the electrode of the first liquid crystal lens L1 and the electrode of the second liquid crystal lens L2. In such an embodiment, the liquid crystal lens LC may include a separate electrode LS not commonly corresponding to the electrode of the first liquid crystal lens L1 and the electrode of the second liquid crystal lens L2. In one exemplary embodiment, for example, the separate electrode LS corresponds to one of the electrodes of the first liquid crystal lens L1 and the second liquid crystal lens L2. The overlap electrode LO is activated when the liquid crystal lens LC functions as the first liquid crystal lens L1 and when the liquid crystal lens LC functions as the second liquid crystal lens L2. The separate electrode LS is partially activated based on the first liquid crystal lens L1 and the second liquid crystal lens L2. In one exemplary embodiment, for example, a first portion of the separate electrode LS is activated when the liquid crystal lens LC functions as the first liquid crystal lens L1, and a second portion of the separate electrode LS is activated when the liquid crystal lens LC functions as the second liquid crystal lens L2. Thus, the overlap electrodes LO of the first liquid crystal lens L1 and the second liquid crystal lens L2 are provided at overlapping portions of the first and second liquid crystal lenses L1 and L2 in the liquid crystal lens LC. The separate electrodes LS are separated from each other in the liquid crystal lens LC. Different voltages are applied to the respective separate electrodes LS such that the first liquid crystal lens L1 or the second liquid crystal lens L2 may be provided using the liquid crystal lens LC.

Referring again to FIG. 6, the liquid crystal lens LC includes a plurality of the first sub liquid crystal portions C2, C4 and C6, a plurality of the second sub liquid crystal portions C1, C3 and C5 and a controller (not shown) that applies voltages to the first sub liquid crystal portions C2, C4 and C6 and the second sub liquid crystal portions C1, C3 and C5 to function as the lens. Refractive indexes in the first sub liquid crystal portions C2, C4 and C6 and the second sub liquid crystal portions C1, C3 and C5 changes based on the applied voltages. In an exemplary embodiment, a first sub liquid crystal portion may be disposed adjacent to a second sub liquid crystal portion.

The first sub liquid crystal portions C2, C4 and C6 and the second sub liquid crystal portions C1, C3 and C5 may have an upper electrode and a lower electrode. The upper electrode and the lower electrode are connected to the controller. Voltages corresponding to the first and second sub liquid crystal portions are applied to the upper electrode and the lower electrode such that liquid crystal molecules in the first and second sub liquid crystal portions have refractive indexes corresponding to the applied voltages. In one exemplary embodiment, for example, the upper electrode and the lower electrode may not overlap each other. The upper electrode and the lower electrode may be disposed in a horizontal direction such that an arrangement of the liquid crystal molecules may be adjusted by the electric field in the horizontal direction.

The first sub liquid crystal portions C2, C4 and C6 are disposed commonly corresponding to both the first liquid crystal lens L1 and the second liquid crystal lens L2. Each of the first sub liquid crystal portions C2, C4 and C6 receives substantially the same voltage when the liquid crystal lens LC functions as the first liquid crystal lens L1 and when the liquid crystal lens LC functions as the second liquid crystal lens L2. The second sub liquid crystal portions C1, C3 and C5 are disposed not commonly corresponding to both the first liquid crystal lens L1 and the second liquid crystal lens L2. Each of the second sub liquid crystal portions C1, C3 and C5 may receive a voltage, e.g., a first voltage, when the liquid crystal lens LC functions as the first liquid crystal lens L1 and may receive a different voltage, e.g., a second voltage, when the liquid crystal lens LC functions as the second liquid crystal lens L2. The second sub liquid crystal portions C1, C3 and C5 have receive different voltages such that the liquid crystal lens LC may alternately functions as the first liquid crystal lens L1 and the second liquid crystal lens L2, which have different focal points.

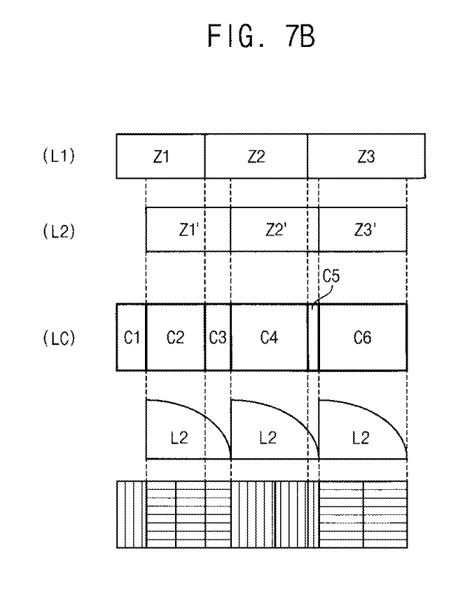

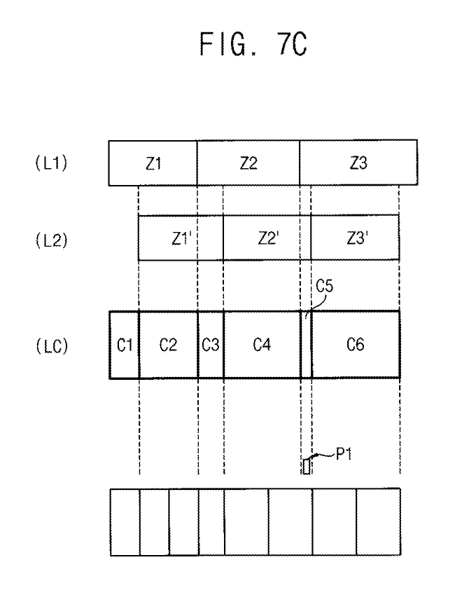

FIGS. 7A to 7C are conceptual diagrams illustrating an exemplary embodiment of a method of driving the liquid crystal lens of FIG. 5.

Referring to FIG. 7A, voltages are respectively applied to the first sub liquid crystal portions C2, C4 and C6 and the second sub liquid crystal portions C1, C3 and C5 such that the liquid crystal lens LC functions as the first liquid crystal lens L1. When the liquid crystal lens LC functions as the first liquid crystal lens L1, a first portion C2 of the first sub liquid crystal portion and a first portion C1 of the second sub liquid crystal portion correspond to a first zone Z1 of the first liquid crystal lens L1.

In a similar way, when the liquid crystal lens LC functions as the first liquid crystal lens L1, a second portion C4 of the first sub liquid crystal portion and a second portion C3 of the second sub liquid crystal portion correspond to a second zone Z2 of the first liquid crystal lens L1, and a third portion C6 of the first sub liquid crystal portion and a third portion C5 of the second sub liquid crystal portion correspond to a third zone Z3 of the first liquid crystal lens L1.

Referring to FIG. 7B, voltages are respectively applied to the first sub liquid crystal portions C2, C4 and C6 and the second sub liquid crystal portions C1, C3 and C5 such that the liquid crystal lens LC functions as the second liquid crystal lens L2. When the liquid crystal lens LC functions as the second liquid crystal lens L2, a first portion C2 of the first sub liquid crystal portion and a first portion C1 of the second sub liquid crystal portion correspond to a first zone Z1′ of the second liquid crystal lens L2.

In a similar way, when the liquid crystal lens LC functions as the second liquid crystal lens L2, a second portion C4 of the first sub liquid crystal portion and a second portion C3 of the second sub liquid crystal portion correspond to a second zone Z2′ of the second liquid crystal lens L2, and a third portion C6 of the first sub liquid crystal portion and a third portion C5 of the second sub liquid crystal portion correspond to a third zone Z3′ of the second liquid crystal lens L2.

In an exemplary embodiment, a liquid crystal panel may be disposed under the liquid crystal lens LC. An exemplary embodiment of a liquid crystal module includes the liquid crystal lens LC and a liquid crystal panel. In such an embodiment, an image displayed on the liquid crystal panel is transmitted to the viewer through the liquid crystal lens LC. The liquid crystal panel may include a plurality of pixels and a black matrix. The second liquid crystal lens L2 provided using the liquid crystal lens LC may be shifted by a half of a width of the pixel of the liquid crystal panel from the first liquid crystal lens L1. As described referring to FIGS. 2A and 2B, when the first liquid crystal lens L1 and the second liquid crystal lens L2 are shifted by a half of a width of the pixel of the liquid crystal panel from each other, a black image and a bright image are alternately transmitted to the viewer such that the viewer may recognize the 3D image.

Referring to FIG. 7C, the liquid crystal lens LC includes first sub liquid crystal portions C2, C4 and C6 and second sub liquid crystal portions C1 and C3. When a width P1 of the second sub liquid crystal portion is less than a minimum electrode width, the second sub liquid crystal portion may be merged with an adjacent sub liquid crystal portion. In one exemplary embodiment, for example, the second sub liquid crystal portion having the width of P1 may be merged with the adjacent first sub liquid crystal portion C6. The minimum electrode width may be defined in a manufacturing process of the liquid crystal lens LC, e.g., a lower limit of a width of a single electrode when providing the electrode in the liquid crystal lens LC during the manufacturing process of the liquid crystal lens LC. When the width of the sub liquid crystal portion is less than the minimum electrode width in the manufacturing process of the liquid crystal lens LC, the sub liquid crystal portion is merged to the adjacent sub liquid crystal portion as the sub liquid crystal portion may not be further divided.

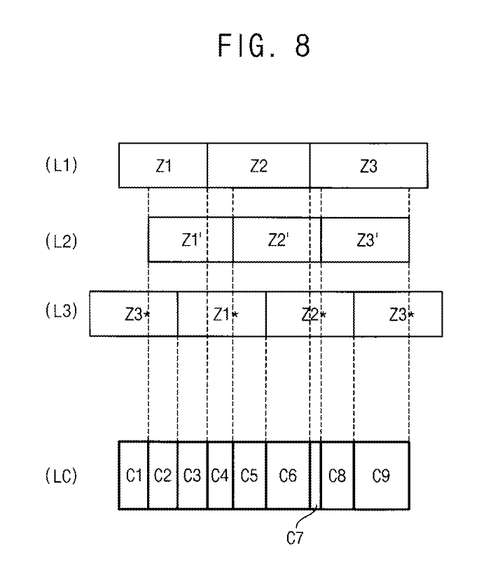

FIG. 8 is a conceptual diagram illustrating an alternative exemplary embodiment of a liquid crystal lens according to the invention.

Referring to FIG. 8, an exemplary embodiment of the liquid crystal lens LC includes first sub liquid crystal portions C3, C6 and C9, second sub liquid crystal portions C2, C5 and C8, third sub liquid crystal portions C1, C4 and C7 and a controller (not shown) that controls the first to third sub liquid crystal portions C1 to C9.

The liquid crystal lens LC may function as the first liquid crystal lens L1, the second liquid crystal lens L2 and the third liquid crystal lens L3. A first portion C3 of the first sub liquid crystal portion, a first portion C2 of the second sub liquid crystal portion and a first portion C1 of the third sub liquid crystal portion correspond to a first zone Z1 of the first liquid crystal lens L1. In a similar way, a second portion C4 of the third sub liquid crystal portion, the first portion C3 of the first sub liquid crystal portion and the first portion C2 of the second sub liquid crystal portion correspond to a first zone Z1′ of the second liquid crystal lens L2. A second portion C5 of the second sub liquid crystal portion, the second portion C4 of the third sub liquid crystal portion and the first portion C3 of the first sub liquid crystal portion correspond to a first zone Z1* of the third liquid crystal lens L3.

In an exemplary embodiment, as shown in FIG. 8, the liquid crystal lens includes three sub liquid crystal portions, but the invention is not limited thereto. In an alternative exemplary embodiment, the liquid crystal lens may include N sub liquid crystal portions, where N is a natural number greater than 2. The liquid crystal lens includes first to N-th sub liquid crystal portions. When the liquid crystal lens includes N sub liquid crystal portions, the liquid crystal lens may form N kinds of lenses. Thus, N kinds of images may be provided to the viewer.

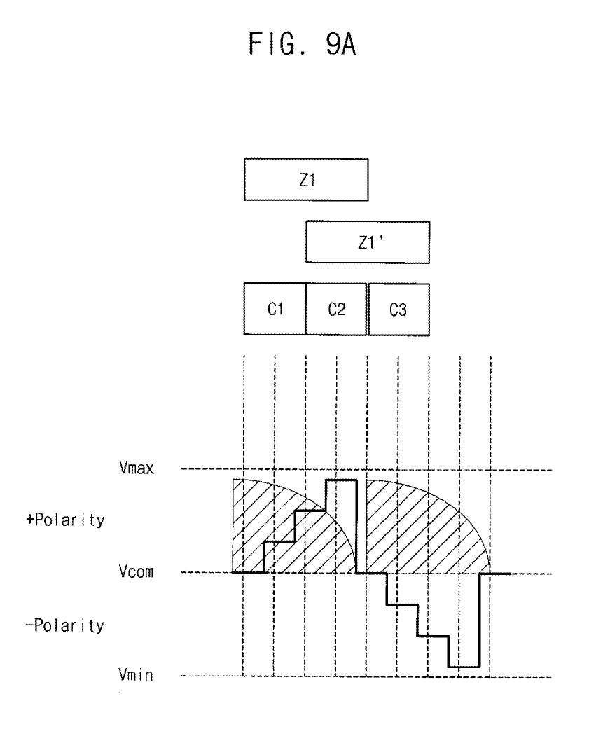

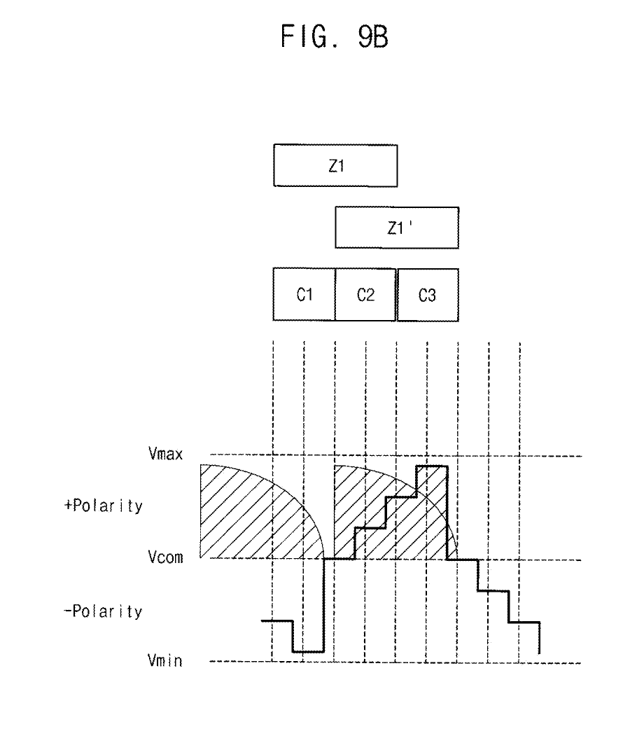

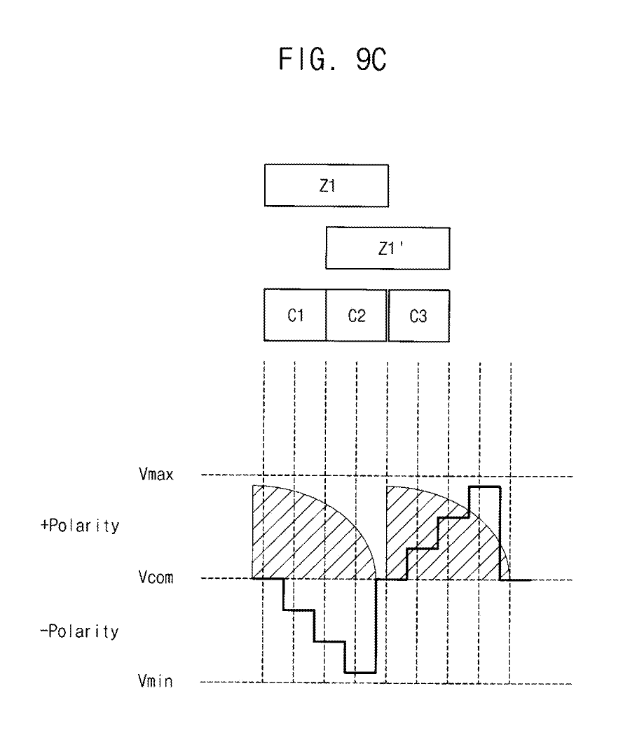

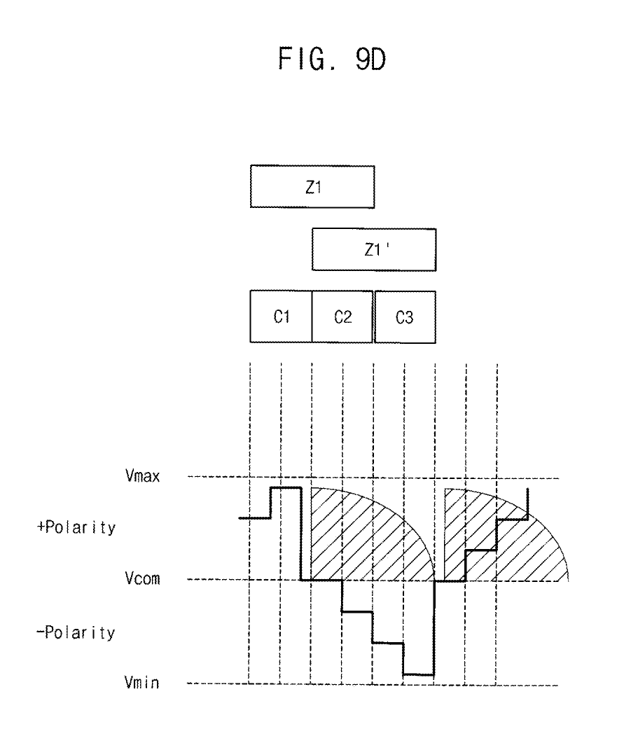

FIGS. 9A to 9D are conceptual diagrams illustrating an exemplary embodiment of a method of driving a liquid crystal lens of a liquid crystal module according to the invention.

In an exemplary embodiment, a method of driving the liquid crystal module includes providing a lens and shifting the lens. In a process of providing a lens, voltages applied to first sub liquid crystal portions C1 and C3 and voltages applied to second sub liquid crystal portions C2 are controlled to provide the lens. The first sub liquid crystal portions C1 and C3 have refractive indexes varied based on the applied voltages. The second sub liquid crystal portions C2 have refractive indexes varied based on the applied voltages. The second sub liquid crystal portions C2 are adjacent to the first sub liquid crystal portions C1 and C3. In a process of shifting the lens, levels of the voltages applied to the first sub liquid crystal portions C1 and C3 is maintained and levels of the voltages applied to the second sub liquid crystal portions C2 are changed to shift the lens.

Referring to FIG. 9A, in an exemplary embodiment of a process of providing the lens, voltages applied to first sub liquid crystal portions C1 and C3 and voltages applied to second sub liquid crystal portions C2 are controlled to provide the lens. The first sub liquid crystal portions C1 and C3 have refractive indexes varied based on the applied voltages. The second sub liquid crystal portions C2 have refractive indexes varied based on the applied voltages. The second sub liquid crystal portions C2 are adjacent to the first sub liquid crystal portions C1 and C3.

Voltages applied to a lens part have a polarity different from voltages applied to an adjacent lens part. In FIG. 9A, voltages having a positive polarity (+) are applied to a first lens part and voltages having a negative polarity (−) are applied to a second lens part. Voltages applied to the adjacent lens parts may be inverted such that a decrease of lens characteristics is effectively prevented.

Referring to FIG. 9B, in an exemplary embodiment of a process of shifting the lens, a polarity of the voltages applied to the first sub liquid crystal portion C2 is not changed. Levels of the voltages applied to the second sub liquid crystal portions C1 and C3 are adjusted to shift the lens part. Voltages having a polarity different from voltages in the process of providing the lens are applied to the second sub liquid crystal portions C1 and C3.

In the process of shifting the lens, the lens part is shifted by a predetermined distance from the lens part in the process of providing the lens. The predetermined distance may be controlled based on areas of the first sub liquid crystal portion C2 and the second sub liquid crystal portions C1 and C3. The predetermined distance may be determined based on positions of a first liquid crystal lens Z1 and a second liquid crystal lens Z1′.

In an exemplary embodiment, the method of driving the liquid crystal module may further include providing an inverted lens and shifting the inverted lens. In a process of providing the inverted lens, voltages having a polarity opposite to a polarity of the voltages applied in the process of providing the lens are applied to the first sub liquid crystal portion C2. Voltages having a polarity same as a polarity of the voltages applied in the process of providing the lens are applied to the second sub liquid crystal portions C1 and C3. A shape of the lens provided in the process of providing the inverted lens is substantially the same as a shape of the lens provided in the process of providing the lens.

In a process of shifting the inverted lens, voltages having a polarity same as a polarity of the voltages applied in the process of providing the inverted lens are applied to the first sub liquid crystal portion C2. Voltages having a polarity opposite to a polarity of the voltages in the process of providing the inverted lens are applied to the second sub liquid crystal portions C1 and C3. A shape of the lens provided in the process of shifting the inverted lens is substantially the same as a shape of the lens provided in the process of shifting the lens.

Referring to FIG. 9C, in the process of providing the inverted lens according to the exemplary embodiment, a polarity of the voltages applied to the first sub liquid crystal portion C2 and a polarity of the voltages applied to the second sub liquid crystal portion C1 and C3 are inverted comparing to the polarities of the voltages applied in the process of providing the lens. The polarity of the voltages applied to the first sub liquid crystal portion C2 is inverted and the polarity of the voltages applied to the second sub liquid crystal portion C1 and C3 is not inverted with respect to the polarities of the voltages applied in the process of shifting the lens.

Comparing to the process of providing the lens, voltages having opposite polarities are applied to the first and second sub liquid crystal portions to provide the lens. In the process of providing the inverted lens, the polarities of the voltages are opposite to the polarities of the voltages in the process of providing the lens, while levels of the voltages are substantially the same as the levels of the voltages applied in the process of providing the lens. Thus, a shape of the lens provided in the process of providing the inverted lens is substantially the same as a shape of the lens provided in the process of providing the lens.

Referring to FIG. 9D, in an exemplary embodiment of the process of shifting the inverted lens, a polarity of the voltages applied to the first sub liquid crystal portion C2 and a polarity of the voltages applied to the second sub liquid crystal portion C1 and C3 are inverted with respect to the polarities of the voltages applied in the process of shifting the lens. The polarity of the voltages applied to the first sub liquid crystal portion C2 is not inverted and the polarity of the voltages applied to the second sub liquid crystal portion C1 and C3 is inverted with respect to the polarities of the voltages applied in the process of providing the inverted lens.

In the process of shifting the inverted lens, voltages having opposite polarities are applied to the first and second sub liquid crystal portions to provide the lens. In the process of shifting the inverted lens, the polarities of the voltages are opposite to the polarities of the voltages applied in the process of shifting the lens, while levels of the voltages are substantially the same as the levels of the voltages applied in the process of shifting the lens. Thus, a shape of the lens provided in the process of shifting the inverted lens is substantially the same as a shape of the lens provided in the process of shifting the lens.

In exemplary embodiments, as described above, the liquid crystal lens includes the first sub liquid crystal portion and the second sub liquid crystal portion such that a single liquid crystal lens may operate as a plurality of the liquid crystal lenses.

In such embodiments, polarities of the voltages applied to the first sub liquid crystal portion and the second sub liquid crystal portion are adjusted such that efficiency of the liquid crystal lens is substantially improved.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A liquid crystal lens comprising:
a plurality of first sub liquid crystal portions having refractive indexes varied based on voltages applied thereto;
a plurality of second sub liquid crystal portions having refractive indexes varied based on voltages applied thereto, wherein the second sub liquid crystal portions are adjacent to the first sub liquid crystal portions, respectively; and
a controller which controls the voltages applied to the first sub liquid crystal portions and the voltage applied to the second sub liquid crystal portions to provide a lens part.

2. The liquid crystal lens of claim 1, wherein
each of the first sub liquid crystal portions and the second sub liquid crystal portions comprises an upper electrode and a lower electrode, which are connected to the controller.

3. The liquid crystal lens of claim 2, wherein the upper electrode and the lower electrode do not overlap each other.

4. The liquid crystal lens of claim 1, wherein
a width of the upper electrode and a width of the lower electrode are equal to or greater than a minimum width defined in a manufacturing process of the upper and lower electrodes.

5. The liquid crystal lens of claim 1, wherein the liquid crystal lens has a plurality of focal points controlled by the controller.

6. The liquid crystal lens of claim 1, wherein the voltages applied to provide the lens part are inverted from voltages applied to provide an adjacent lens part.

7. A liquid crystal lens comprising:
first to N-th sub liquid crystal portions having refractive indexes varied based on voltages applied thereto; and
a controller which controls the voltages applied to the first to N-th sub liquid crystal portions to provide a lens part,
wherein N is a natural number greater than 2.

8. The liquid crystal lens of claim 7, wherein each of the first to N-th sub liquid crystal portions comprises an upper electrode and a lower electrode, which are connected to the controller.

9. The liquid crystal lens of claim 8, wherein the upper electrode and the lower electrode do not overlap each other.

10. A liquid crystal module comprising:
a liquid crystal lens comprising:
a plurality of first sub liquid crystal portions having refractive indexes varied based on voltages applied thereto;
a plurality of second sub liquid crystal portions having refractive indexes varied based on voltages applied thereto, wherein the second sub liquid crystal portions are adjacent to the first sub liquid crystal portions, respectively; and
a controller which controls the voltages applied to the first sub liquid crystal portions and the voltages applied the second sub liquid crystal portions to provide a lens part; and
a liquid crystal panel disposed under the liquid crystal lens, wherein the liquid crystal panel comprises a plurality of pixels.

11. The liquid crystal module of claim 10, wherein each of the first sub liquid crystal portions and the second sub liquid crystal portions comprises an upper electrode and a lower electrode, which are connected to the controller.

12. The liquid crystal module of claim 11, wherein the upper electrode and the lower electrode do not overlap each other.

13. The liquid crystal module of claim 10, wherein a focal point of the lens part is shifted by a half of a width of the pixel of the liquid crystal panel by the controller.

14. A method of driving a liquid crystal module, the method comprising:
providing a lens part using a plurality of first sub liquid crystal portions of a liquid crystal lens of the liquid crystal module and a plurality of second sub liquid crystal portions of the liquid crystal lens by controlling voltages applied to the first sub liquid crystal portions and voltages applied to the second sub liquid crystal portions, wherein the first sub liquid crystal portions having refractive indexes varied based on the voltages applied thereto, the second sub liquid crystal portions having refractive indexes varied based on the voltages applied thereto, and the second sub liquid crystal portions are adjacent to the first sub liquid crystal portions, respectively; and
shifting the lens part by maintaining levels of the voltages applied to the first sub liquid crystal portions and changing levels of the voltages applied to the second sub liquid crystal portions.

15. The method of claim 14, wherein
the liquid crystal module further comprises a liquid crystal panel disposed under the liquid crystal lens, and
the liquid crystal panel displays an image of a frame, wherein the shifting the lens part is performed every frame.

16. The method of claim 15, wherein the voltages applied to provide the lens part have a polarity different from voltages applied to provide an adjacent lens part.

17. The method of claim 14, wherein the shifting the lens part comprises:
applying voltages having a polarity same as a polarity of the voltages applied to the first sub liquid crystal portions for the providing the lens part, to the first sub liquid crystal portion; and
applying voltages having a polarity opposite to a polarity of the voltages applied to the second sub liquid crystal portions for the providing the lens part, to the second sub liquid crystal portion.

18. The method of claim 17, further comprising:
providing an inverted lens part by applying voltages having a polarity opposite to a polarity of the voltages applied to the first sub liquid crystal portions for the providing the lens part to the first sub liquid crystal portions and applying voltages having a polarity opposite to a polarity of the voltages applied to the second sub liquid crystal portions for the providing the lens part to the second sub liquid crystal portions,
wherein the providing the inverted lens part is performed after the shifting the lens part.

19. The method of claim 18, further comprising:
shifting the inverted lens part by applying voltages having a polarity opposite to a polarity of the voltages applied to the first sub liquid crystal portions for the shifting the lens part to the first sub liquid crystal portions and applying voltages having a polarity opposite to a polarity of the voltages applied to the second sub liquid crystal portions for the shifting the lens part to the second sub liquid crystal portions,
wherein the shifting the inverted lens part is performed after the providing the inverted lens part.
